(19) United States
(12) Patent Application Publication
(10) Pub. No.: US 2015/0097025 A1
(43) Pub. Date: Apr. 9, 2015

(54) ELECTRODE FORMING DEVICE AND ELECTRODE FORMING METHOD

(71) Applicant: Hitachi, Ltd., Tokyo (JP)

(72) Inventors: Hirokuni KURIHARA, Tokyo (JP); Shoichi GUNJI, Tokyo (JP); Takao KAWANO, Tokyo (JP); Tomoyuki YAHAGI, Tokyo (JP); Naoaki HASHIMOTO, Tokyo (JP)

(21) Appl. No.: 14/504,622

(22) Filed: Oct. 2, 2014

(30) Foreign Application Priority Data
Oct. 3, 2013 (JP) 2013-208472

(51) Int. Cl. B23K 3/06; B23K 1/20; B23K 3/08

(52) U.S. Cl. CPC B23K 3/0623; B23K 3/082; B23K 1/203; B23K 2201/36
USPC 228/223; 228/41

(57) ABSTRACT

An electrode forming device has a flux application unit that applies flux on a substrate; a plurality of ball filling units that are arranged in series at a downstream side of the flux application unit and fill conductive balls on the substrate applied with the flux to form electrodes; and a first conveying device, a second conveying device, a first bypass conveyor and a second bypass conveyor that convey the substrate to one of the ball filling units and conveys the substrate in such a way as to bypass the other ball filling unit.

### CROSS REFERENCE TO RELATED APPLICATION

The present application claims benefit of the filing date of Japanese Patent Application No. 2013-208472 filed on Oct. 3, 2013, the disclosure of which is incorporated herein by reference.

### BACKGROUND OF THE INVENTION

1. Field of the Invention

The invention relates to an electrode forming device which forms electrodes on a substrate and an electrode forming method.

2. Description of the Related Art

Surface-mounted electronic components such as a BGA (Ball Grid Array) and a CSP (Chip Size Package) are mounted in computers, cellular phones, digital appliances and the like. A number of electrodes (bumps) formed in a hemisphere shape are provided on rear surfaces of the electronic components mentioned above. The number of contacts between the substrate and the electronic components can be increased by providing the electrodes on the rear surfaces of the electronic components. This makes mounting areas of the electronic components smaller and realizes downsizing and densification thereof.

A number of electrodes (bumps) are formed on points corresponding to electrodes of the electronic components on the substrate where the surface-mounted electronic components are mounted. At first, flux is applied on the substrate via a mask for flux application having a number of bores therein. Then, conductive balls are filled on the flux mentioned above via a mask for conductive ball filling having a number of bores therein.

For example, JP4933367B discloses a ball loading device having a flux application device which applies the flux on a wafer and a ball filling device which fills conductive balls on the wafer applied with the flux thereon.

In the ball loading device disclosed in JP4933367B, one ball filling device is arranged at a downstream side of one flux application device.

### SUMMARY OF THE INVENTION

Generally, a conductive ball filling process takes much time than a flux application process. For example, the flux application process takes about 30 seconds while the conductive ball filling process takes about 60 seconds for one substrate.

As described above, the ball loading device disclosed in JP4933367B has the flux application device and the ball filling device arranged in series. In this case, the ball filling device becomes a bottleneck in a substrate treatment process (shortly, substrates are delayed in a ball printer), causing problem such that process efficiency as a whole system lowers.

Therefore, an aspect of the invention is to provide an electrode forming device and an electrode forming method having high process efficiency.

To solve the problem, an electrode forming device according to the invention has a flux application unit that applies flux on a substrate; a plurality of ball filling units that are arranged in series at a downstream side of the flux application unit and fill a conductive ball on the substrate applied with the flux to form an electrode; and a bypass unit that conveys the substrate to one ball filling unit and conveys the substrate in such a way as to bypass the other ball filling unit.

Details thereof will be explained in the detailed description of preferred embodiments.

The invention can provide an electrode forming device and an electrode forming method having high process efficiency.

### BRIEF DESCRIPTION OF THE DRAWINGS

FIG. 1 is a schematic plan view illustrating a structure including an electrode forming device according to a first embodiment of the invention, a loader and an inspection/repair device;

FIG. 2 is a cross sectional view of a flux application unit seen from an A-A line in FIG. 1;

FIG. 3 is a cross sectional view of a ball filling unit in a first ball printer seen from a B-B line in FIG. 1;

FIG. 4 is a flowchart illustrating a process of a first conveying device;

FIG. 5 is a flowchart illustrating a process of a second conveying device;

FIG. 6 is a flowchart illustrating a process of a third conveying device;

FIGS. 7A to 7D are schematic exemplary (plan) views which illustrate substrate processing in chronological order from FIGS. 7A to 7D;

FIG. 8 is a schematic plan view illustrating a structure including an electrode forming device according to a second embodiment of the invention, a loader and an inspection/repair device;

FIG. 9 is a flowchart illustrating a process of a third conveying device; and

FIG. 10 is a schematic plan view illustrating a structure of electrode forming devices according to a comparison example.

### DETAILED DESCRIPTION OF THE PREFERRED EMBODIMENTS

### First Embodiment

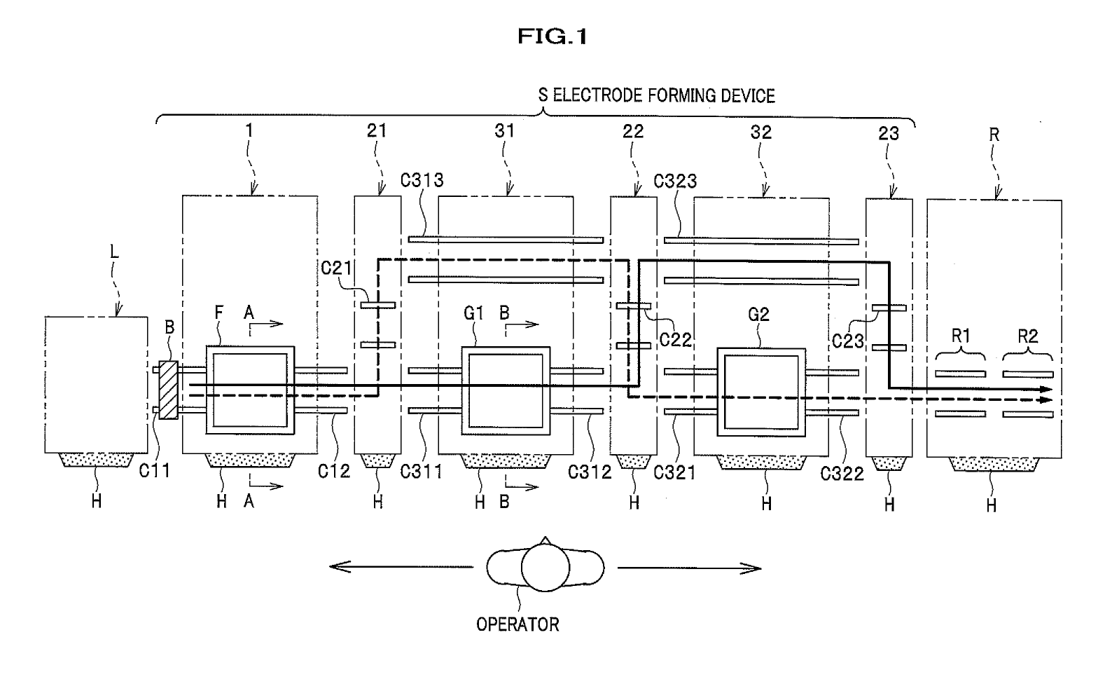

FIG. 1 is a schematic plan view illustrating a structure including an electrode forming device according to the embodiment, a loader and an inspection/repair device. An arrow indicated by a thick line and an arrow indicated by a broken line in FIG. 1 indicate conveyance paths for the substrate B, respectively.

The electrode forming device S is a device which applies flux on points corresponding to circuit patterns of the substrate B which is supplied from a loader L one by one, and fills conductive balls thereon to form electrodes. The substrate B is a plate-shaped member on which chips and the like cutout from a wafer are mounted, and, on which predetermined circuit patterns are formed.

The above-mentioned flux is applied on the substrate B to fix the conductive balls by adhesion force thereof and to eliminate oxides from surfaces of the conductive balls. The conductive balls are, for example, soldering balls having a diameter about 0.05 mm to 0.3 mm and are filled on the substrate B applied with the flux.

### <Structure of the Electrode Forming Device>

The electrode forming device S has a flux printer 1, a first conveying device 21, a first ball printer 31, a second conveying device 22, a second ball printer 32 and a third conveying device 23 from an upstream side (left side in FIG. 1).

### (Flux Printer)

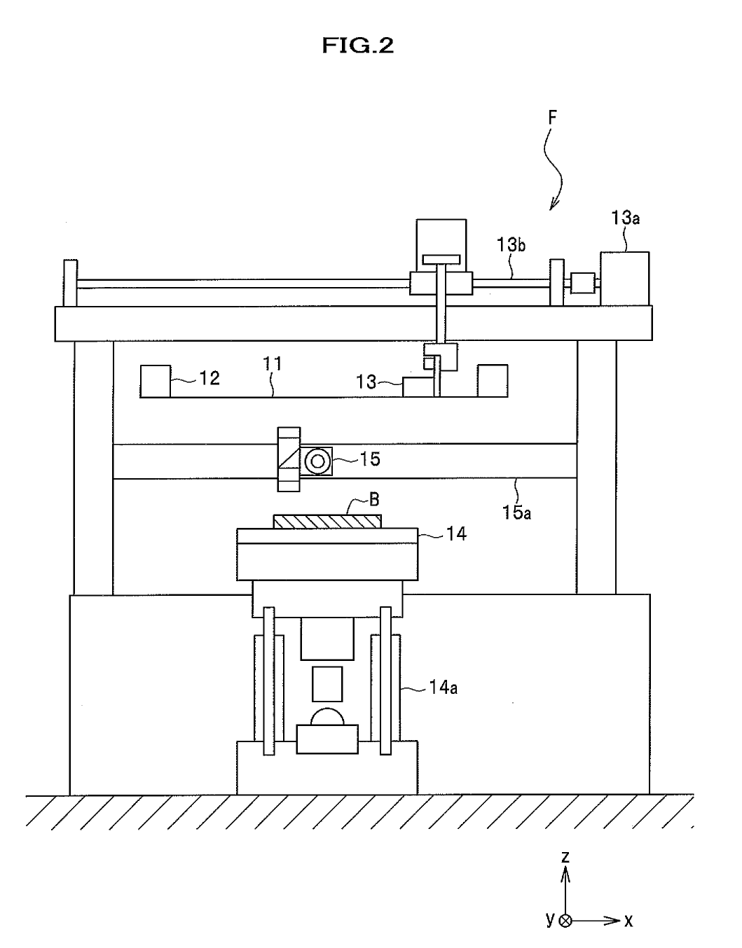

The flux printer 1 is a device which pushes to apply the flux on the substrate B disposed under a mask 11 (see FIG. 2) through a number of bores formed in the mask 11 for flux application.

A number of substrates B are accommodated in the loader L arranged at an upstream side of the flux printer 1. The loader L is a device which supplies new substrates B one by one to an import conveyor C11 whenever the flux printer 1 processes the substrate B.

The flux printer 1 has the import conveyor C11, a flux application unit F and an export conveyor C12.

The import conveyor C11 is a device which conveys the substrate B supplied from the loader L to the flux application unit F. The import conveyor C11 has, for example, a drive wheel (not shown) driven by a motor (not shown) and a ring-shaped belt conveyor set on the drive wheel. A pair of belt conveyors extending in a right-left direction is schematically illustrated in FIG. 1.

The export conveyor C12 is a device which conveys the substrate B processed by the flux application unit F to a downstream side. The export conveyor C12 has the same structure as that of the above-mentioned import conveyor C11 (the same applies to the other conveyors C311, C312, C321 and C322).

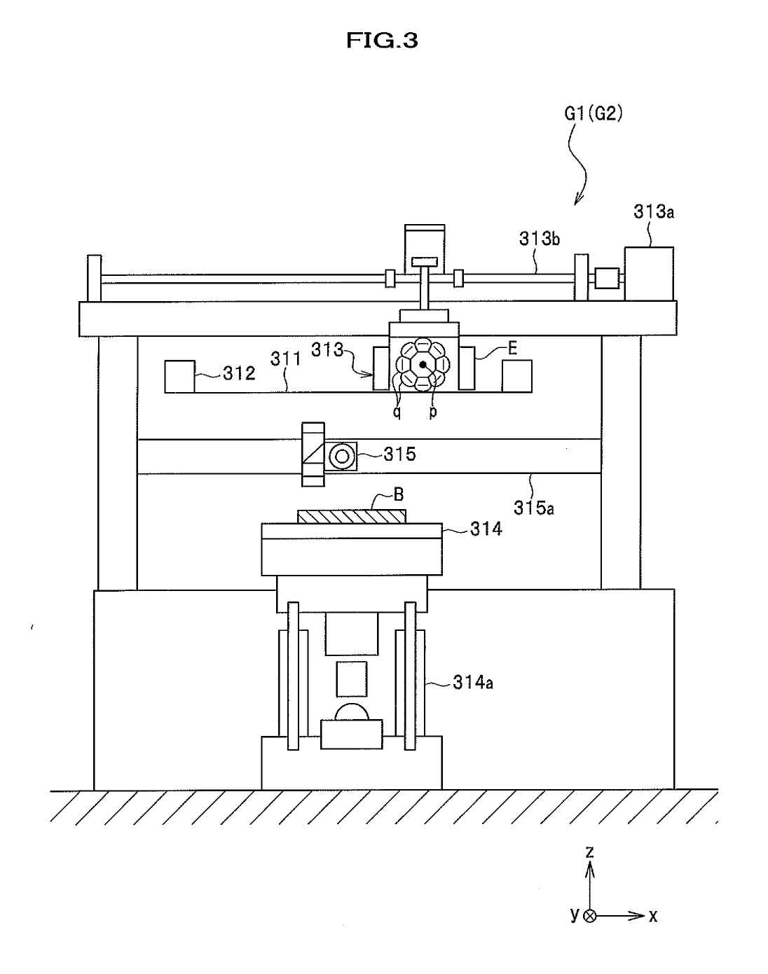

FIG. 2 is a cross sectional view of the flux application unit seen from an A-A line in FIG. 1. FIG. 2 illustrates that the substrate B is apart from the mask 11 and a camera 15 is placed between the substrate B and the mask 11. When the flux is applied on the substrate B, the camera 15 recedes and an upper surface of the substrate B is in close contact on a lower surface of the mask 11 (the same applies to FIG. 3).

The flux application unit F has the mask 11 formed with a number of bores therein, a plate frame 12 which fixes the mask 11, a squeegee head 13 arranged above the mask 11, a printing table 14 on which the substrate B is mounted and the camera 15 which images alignment marks (not shown) of the mask 11 and the substrate B.

The mask 11 is a metal mask formed with a number of bores corresponding to the circuit patterns of the substrate B and extends along an XY-plane (horizontal plane) illustrated in FIG. 2. The plate frame 12 is a frame body having a rectangular shape in planar view and fixes a periphery of the mask 11.

The squeegee head 13 is a device which pushes the flux downward through the bores in the mask 11 (that is, a paddle used for applying the flux). The squeegee head 13 moves in an X-direction by rotating a ball screw shaft 13b by a motor 13a.

The printing table 14 is a device which adjusts a position of the substrate B in the X-direction, a Y-direction and a θ-direction (rotation on the XY-plane), brings the substrate B into contact on the mask 11 and separates the substrate B from the mask 11 by moving in a Z-direction (vertical direction) by an elevating mechanism 14a.

A table conveyor (not shown) is provided on the printing table 14. The table conveyor is configured to receive the substrate B conveyed by the import conveyor C11 (see FIG. 1), moves the substrate B to a predetermined position and conveys the substrate B to the export conveyor C12 after the flux application thereon.

The camera 15 is a two-view camera which can image an upper side and a lower side thereof. The camera 15 is configured to be capable of moving in the X-direction along a frame 15a and to be capable of moving in the Y-direction along another frame (not shown).

The camera 15 images the alignment mark (not shown) printed on the lower surface of the mask 11 and the alignment mark (not shown) printed on the upper surface of the substrate B respectively to output the imaged alignment marks to a controller (not shown). The controller executes an imaging process based on the imaged result and moves the printing table 14 (substrate B) to cancel a positional displacement amount of the substrate B.

### (First Conveying Device)

As illustrated in FIG. 1, the first conveying device 21 (conveying unit) is arranged at a downstream side of the flux printer 1. The first conveying device 21 is a device which assigns the substrate B conveyed from the flux application unit F via the export conveyor C12 to either one of the import conveyor C311 and a first bypass conveyor C313 of the first ball printer 31.

The first conveying device 21 has a conveyor C21 which can convey the substrate B in the right-left direction in FIG. 1 and a conveying unit (not shown) which conveys the conveyor C21 in an up-down direction in FIG. 1.

The conveying unit (not shown) is, for example, a ball screw mechanism, and conveys the conveyor C21 to a position adjacent to the import conveyor C311 or the first bypass conveyor C313.

After receiving the substrate B from the export conveyor C12 of the flux printer 1, the conveyor C21 conveys the substrate B to the import conveyor C311 or the first bypass conveyor C313 arranged at a downstream side thereof.

### (First Ball Printer)

The first ball printer 31 is arranged at a downstream side of the first conveying device 21. The first ball printer 31 has the import conveyor C311, a first ball filling unit G1, the export conveyor C312 and the first bypass conveyor C313.

Since the structures of the import conveyor C311 and the export conveyor C312 are the same as those of the import conveyor C11 and the export conveyor C12, the explanations thereof will be omitted.

FIG. 3 is a cross sectional view of the ball filling unit of the first ball printer along a B-B line in FIG. 1. The first ball filling unit G1 is a device which fills the conductive balls on the substrate B applied with the flux to form the electrodes.

The first ball filling unit G1 has a mask 311 having a number of bores therein, a plate frame 312 which fixes the mask 311, a filling head 313 arranged above the mask 311, a printing table 314 on which the substrate B is mounted, and a camera 315 which images alignment marks (not shown) printed on the mask 311 and the substrate B.

The structure of the first ball filling unit G1 (see FIG. 3) is the same as that of the flux application unit F (see FIG. 2) except the filling head 313. Accordingly, the same portions as the flux application unit F will not be explained.

The filling head 313 illustrated in FIG. 3 is a device which drops the conductive balls downward through the bores in the mask 311, and fills the conductive balls on the substrate B which is in close contact on a lower surface of the mask 311.

The filling head 313 has, for example, a plurality of squeegees q (eight in FIG. 3) fixed on a shaft p and a cover E which accommodates the squeegees q. The conductive balls present in the cover E are filled on the substrate B through the mask 311 by rotating the shaft p mentioned above. The filling head 313 moves in the X-direction by rotating the ball screw shaft 313b with the help of the motor 313a. The structure of the filling head 313 is not limited to the example illustrated in FIG. 3.

The bypass conveyor C313 (first bypass path) illustrated in FIG. 1 is a device which conveys the substrate B to the downstream side such that the substrate B bypasses the first ball filling unit G1, and is arranged with the first ball filling unit G1 in parallel. The first bypass conveyor C313 is, for example, arranged with the import conveyor C311 and the export conveyor C312 approximately in parallel. An upstream end of the first bypass conveyor C313 is adjacent to the first conveying device 21 and a downstream end thereof is adjacent to the second conveying device 22.

A “first bypass unit” by which the substrate B applied with the flux by the flux application unit F bypasses the first ball filling unit G1 to be conveyed to the second ball filling unit G2 is structured to include the first conveying device 21 and the first bypass conveyor C313.

### (Second Conveying Device)

The second conveying device 22 (conveying unit) illustrated in FIG. 1 is arranged at a downstream side of the first ball printer 31. The second conveying device 22 conveys the substrate B conveyed from the first ball filling unit G1 via the export conveyor C312 to the second bypass conveyor C323 (see the arrow indicated by the thick line).

Further, the second conveying device 22 conveys the substrate B conveyed via the first bypass conveyor C313 to the import conveyor C321 of the second ball printer 32 (see the arrow indicated by the broken line).

The second conveyor device 22 has a conveying unit (not shown) which conveys the conveyor C22 in the up-down direction in FIG. 1. The conveying unit conveys the conveyor C22 to a position adjacent to the import conveyor C321 or a position adjacent to the second bypass conveyor C323 of the second ball printer 32.

Since the structure of the second conveying device 22 is the same as that of the first conveying device 21 mentioned above, the explanation thereof will be omitted.

### (Second Ball Printer)

The second ball printer 32 illustrated in FIG. 1 is arranged at a downstream side of the second conveying device 22. In other words, the second ball printer 32 is arranged with the first ball printer 31 in series.

The second ball printer 32 has the import conveyor 0321, the second ball filling unit G2, the export conveyor C322 and the second bypass conveyor C323. As illustrated in FIG. 1, the second bypass conveyor C323 (second bypass path) is arranged with the second ball filling unit G2 in parallel.

The structure of the second ball printer 32 is the same as that of the first ball printer 31, the explanation thereof will be omitted.

A “second bypass unit” by which the substrate B filled with the conductive balls by the first ball filling unit G1 bypasses the second ball filling unit G2 to be conveyed to a downstream side is structured to include the second conveying device 22 and the second bypass conveyor C323.

Further, a “bypass unit” which conveys the substrate B to one ball filling unit and conveys the substrate B in such a way as to bypass the other ball filling unit is structured to include the conveying devices 21, 22, 23 and the bypass conveyors C313, C323.

### (Third Conveying Device)

The third conveying device 23 illustrated in FIG. 1 is arranged at a downstream side of the second ball printer 32. The third conveying device 23 conveys the substrate B which is conveyed via the export conveyor C322 or the second bypass conveyor C323 to the inspection/repair device R.

The third conveying device 23 has a conveying unit (not shown) which conveys the conveyor C23 in the up-down direction in FIG. 1. The conveying unit conveys the conveyor C23 to a position adjacent to the export conveyor C322 or a position adjacent to the second bypass conveyor C323 of the second ball printer 32. The structure of the third conveying device 23 is the same as that of the first conveying device 21 mentioned above, and the explanation thereof will be omitted.

The inspection/repair device R having an inspection unit R1 and a repair unit R2 is installed at a downstream side of the third conveying device 23. The inspection unit R1 is a device which inspects whether the conductive balls are filled on predetermined points on the substrate B. The repair unit R2 is a device which refills the conductive balls on the substrate B based on an inspection result by the inspection unit R1.

### (Control Device)

Each of the flux printer 1, the first conveying device 21, the first ball printer 31, the second conveying device 22, the second ball printer 32 and the third conveying device 23 has a control device (not shown). The control device of each device is structured to include a CPU (Central Processing Unit), a ROM (Read Only Memory), a RAM (Random Access Memory) and electronic circuits (not shown) such as various interfaces, and executes various processes based on the set programs. Further, respective control devices are connected to be capable of communicating with one another.

The control device of each device is referred to as “control device” correctively hereinbelow.

Further, each device mentioned above has an operation section which is operated by an operator, a display section which indicates a state of the device and the like at a position indicated by a sign H. Each device is arranged such that both the operation section and the display section face at one side (lower side in FIG. 1).

Accordingly, the operator only to monitor the operation section/display section of each device in the right-left direction in FIG. 1, and a load on the operator who monitors operation of the electrode forming device S can be decreased (the details thereof will be explained later).

### <Operations of the Electrode Forming Device>

Next, operations of the electrode forming device S will be briefly explained. When one substrate B is considered, the substrate B is processed as follows.
1. applying the flux
2. conveying to the ball filling unit
3. filling the conductive balls
4. conveying to the inspection/repair device
5. inspection/repair process

When the substrate B is processed, the following time is required for the processes by the flux application unit F, the first ball filling unit G1, the second ball filling unit G2 and the inspection/repair device R.

| Flux print | First ball | Second ball | Inspection/repair |
|---|---|---|---|
| unit | filling unit | filling unit | device |
| 30 secs/piece | 60 secs/piece | 60 secs/piece | 30 secs/piece |

Thus, the processes by the first ball filling unit G1 and the second ball filling unit G2 take twice the time compared with the process by the flux application unit F. In order to process the substrates B smoothly, the electrode forming device S is operated as follows using the conveying devices 21, 22, 23 and the bypass conveyors C313, C323.

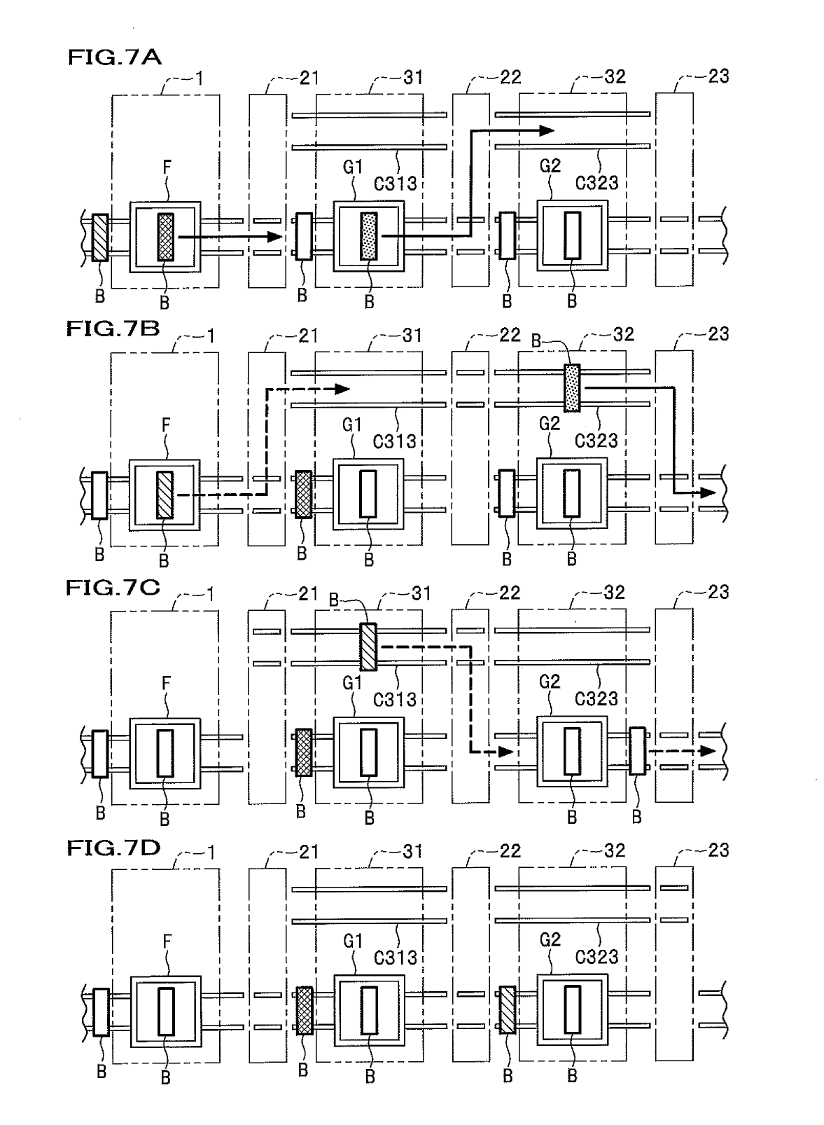

As illustrated in FIGS. 7A to 7D, each import conveyor C11, C311 and C321 also has a function as standby position for the substrate B. This can reduce the standby time from which the current substrate B is conveyed to the downstream side to which a next substrate B is processed.

### (1. Flux Application)

The control device temporarily positions the substrate B conveyed by the import conveyor C11 (see FIG. 1), and then, positions the substrate B in an XYθ-direction by the printing table 14 (see FIG. 2). The process is executed by moving the printing table 14 so as to cancel a positional displacement amount based on the imaged result of the camera 15.

Next, the controller brings the printing table 14 up by the elevating mechanism 14a (see FIG. 2) to closely contact the upper surface of the substrate B on the lower surface of the mask 11. In this state, the squeegee head 13 applies the flux on the substrate B (flux application process). Then, the controller brings the printing table 14 down by the elevating mechanism 14a to separate the substrate B from the mask 11.

The substrate B applied with the flux is conveyed to the first conveying device 21 located at the downstream side by the export conveyor C12 (see FIG. 1).

### (2-1. Conveying to the Ball Filling Unit: First Conveying Device)

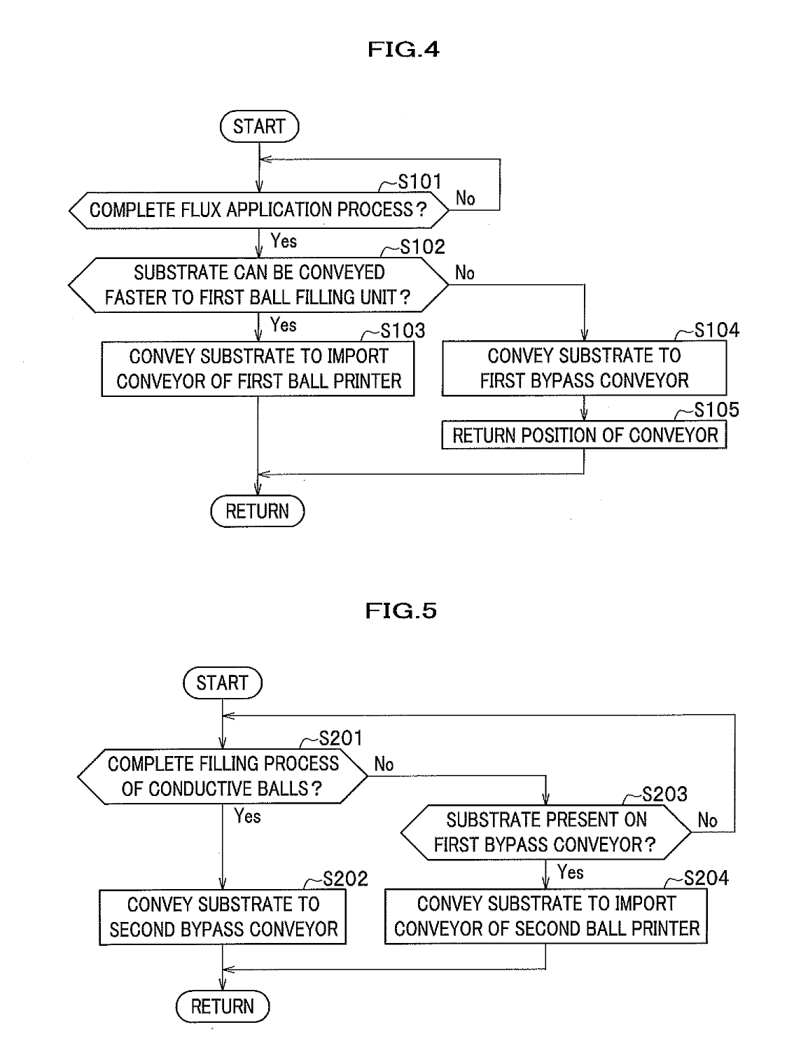

FIG. 4 is a flowchart illustrating processes of the first conveying device.

In step S101, the control device decides whether the flux application process by the flux application unit F completes. In case that the flux application process completes, that is, a new substrate B is conveyed to the export conveyor C12 (S101: Yes), the process of the control device proceeds to step S102.

On the other hand, in case that the flux application process does not complete (S101: No), the control device repeats the process of step S101.

In step S102, the control device decides whether the substrate B can be convoyed to the filling unit G1 faster than the second ball filling unit G2. In other words, as to the processes currently executed by the first ball filling unit G1 and the second ball filling unit G2 respectively, the control device specifies which ball filling unit has a faster scheduled completion time of the processes.

In case that the substrate B can be conveyed to the first ball filling unit G1 faster than the second ball filling unit G2 (S102: Yes), the process of the control device proceeds to step S103. In step S103, the control device conveys the substrate B to the import conveyor C311 of the first ball printer 31 (see the arrow indicated by the thick line in FIG. 7A).

Namely, the control device moves the substrate B mounted on the conveyor C21 (see FIG. 7A) to a position adjacent to an upstream end of the import conveyor C311 by the above-mentioned conveying unit (not shown). Then, the control device conveys the substrate B to the import conveyor C311 by the conveyor C21. Then, the substrate B conveyed to the import conveyor C311 is filled with the conductive balls by the first ball filling unit G1.

In step S102 of FIG. 4, in case that the substrate B can be conveyed to the second ball filling unit G2 faster than the first ball filling unit G1 (S102: No), the process of the control device proceeds to step S104.

In step S104, the control device conveys the substrate B to the first bypass conveyor C313 by the first conveying device 21 (bypass process: see the arrow indicated by the broken line in FIG. 7B). Next, in step S105, the control device moves the conveyor C21 up to a position adjacent to the export conveyor C12. In other words, the control device returns the position of the conveyor C21, and the control device prepares to receive a next substrate B conveyed from the export conveyor C12.

### (2-2. Conveying to the Ball Filling Unit: Second Conveying Device)

FIG. 5 is a flowchart illustrating processes of the second conveying device.

In step S201, the control device decides whether the filling process of the conductive balls by the first ball filling unit G1 completes. In case that the filling process of the conductive balls completes, in other words, in case that a new substrate B is conveyed to the export conveyor C312 (S201: Yes), the process of the control device proceeds to step S202.

In step S202, the control device conveys the substrate B to the second bypass conveyor C323 by the second conveying device 22 (bypass process: see the arrow indicated by the thick line in FIG. 7A). The second bypass conveyor C323 conveys the substrate B to a downstream side in such a way as to bypass the second ball filling unit G2.

After the process of step S202, the control device preferably retains the conveyor C22 at a position adjacent to the second bypass conveyor C323. This is because that the processing timing of the first ball printer 31 and the second ball printer 32 often deviates from each other and that a new substrate B is very likely conveyed from the first bypass conveyor C313.

In step S201, in case that the filling process of the conductive balls by the first ball filling unit G1 does not complete (S201: No), the process of the control device proceeds to step S203. In step S203, the control device decides whether the substrate B is present on the first bypass conveyor C313. The decision process is executed based on signals from a sensor (not shown) provided, for example, above the first bypass conveyor C313.

In case that the substrate B is present on the first bypass conveyor C313 (S203: Yes), the process of the control device proceeds to step S204. In step S204, the control device conveys the substrate B to the export conveyor 0321 of the second ball printer 32 by the second conveying device 22 (see the arrow indicated by the broken line in FIG. 7C). The conductive balls are filled on the substrate B by the second ball filling unit G2.

After the process of step S204, the control device preferably retains the conveyor C22 at a position adjacent to the export conveyor C312 of the first ball printer 31. This is because that a next substrate B is very likely conveyed via the export conveyor C312.

### (3. Filling of the Conductive Balls)

The control device of the first ball filling unit G1 temporarily positions the substrate B conveyed by the export conveyor C311 (see FIG. 1), and then, positions the substrate B in the XYθ-direction with the help of the printing table 314 (see FIG. 3). Next, the control device brings the printing table 314 up by the elevating mechanism 314a to come into close contact the upper surface of the substrate B on the lower surface of the mask 311. The filling head 313 fills the conductive balls on the substrate B (ball filling process).

Further, the control device brings the printing table 314 down by the elevating mechanism 314a to separate the substrate B from the mask 311. The substrate B filled with the conductive balls is conveyed to the second conveying device 22 located at a downstream side by the export conveyor C312.

Likewise, the substrate B processed with the filling process by the second ball filling unit G2 (see FIG. 1) is conveyed to the third conveying device 23 located at a downstream side by the export conveyor C322.

### (4. Conveying to the Inspection/Repair Device)

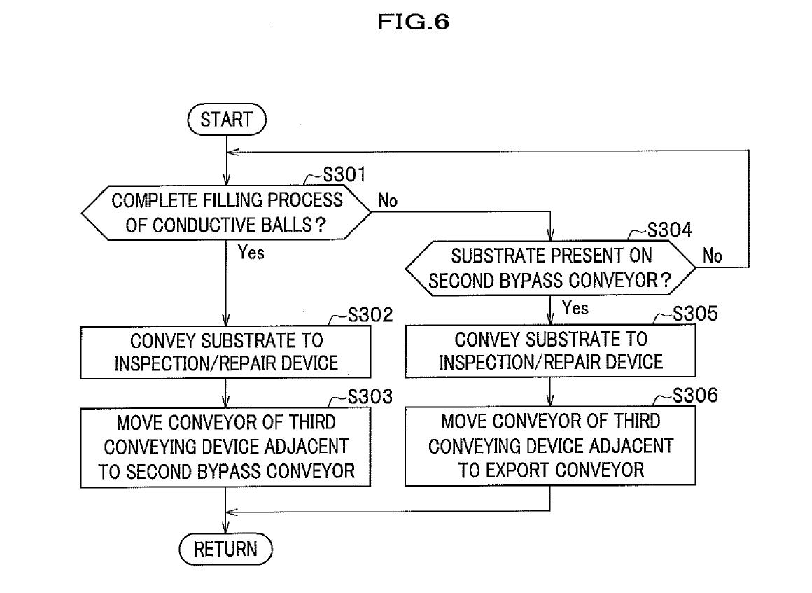

FIG. 6 is a flowchart illustrating processes of the third conveying device.

In step S301, the control device decides whether the filling process of the conductive balls by the second ball filling unit G2 (see FIG. 1) completes. In case that the filling process of the conductive balls completes, that is, in case that the substrate B is conveyed to the export conveyor C322 (S301: Yes), the process of the control device proceeds to step S302.

In step S302, the control device receives the substrate B from the export conveyor C322 by the third conveying device 23 and conveys the substrate B to the inspection/repair device R (see the arrow indicated by the broken line in FIG. 7C).

In step S303, the control device moves the conveyor C23 of the third conveying device 23 to a position adjacent to the second bypass conveyor C323 (see FIG. 7B). Thus, the substrate B conveyed from the second bypass conveyer C32 can be received quickly and can be conveyed to a downstream side.

In step S301, in case that the filling process of the conductive balls by the second ball filling unit G2 (see FIG. 1) does not complete (S301: No), the process of the control device proceeds to step S304. In step S304, the control device decides whether the substrate B is present on the second bypass conveyor C323.

In case that the substrate B is present on the second bypass conveyor C323 (S304: Yes), the process of the control device proceeds to step S305. On the other hand, in case that the substrate B is not present on the second bypass conveyor C323 (S304: No), the process of the control device returns to step S301.

In step S305, the control device receives the substrate B from the second bypass conveyor C323 by the third conveying device 23 and conveys the substrate B to the inspection/repair device R (see the arrow indicated by the thick line in FIG. 7B).

In step S306, the control device moves the conveyor C23 of the third conveying device 23 to a position adjacent to the export conveyor C322 of the second ball printer 32 (see FIG. 7D). Thus, the substrate B conveyed from the export conveyor C322 can be received quickly and can be conveyed to a downstream side.

### (5. Inspection/Repair Process)

The inspection/repair device R (see FIG. 1) inspects a surface of the substrate B by the inspection unit R1. In case that the conductive balls are not filled on the predetermined points corresponding to the circuit patterns of the substrate B, the inspection/repair device R executes a repair process for the conductive balls by the repair unit R2.

The substrate B executed with the inspection/repair processes is applied with a heat treatment in a reflow device (not shown) located at a downstream side. Consequently, the conductive balls filled on the substrate B are dissolved and are performed with interface bonding.

### <Effect>

According to the electrode forming device S of the embodiment, the substrate B is assigned to one of the ball filling units G1, G2 by the conveying devices 21, 22, and is conveyed by the bypass conveyors C313, C323 in such a way as to bypass the other of the ball filling unit G1 and G2.

Thus, the substrate B can be conveyed via the bypass conveyors C313, C323 and the like during the processes of the ball filling units G1 and G2, and the processes by the flux application unit F and the ball filling units G1 and G2 can be maintained incessantly.

In other words, the substrates B can be processed smoothly even when the processing time of the ball filling units G1, G2 (60 seconds) is longer than the processing time of the flux application unit F (30 seconds). For example, the embodiment can shorten the required time for a set of processes in half the time compared with an electrode forming device having one flux application unit and one ball filling unit disposed at the downstream side thereof.

Further, since the set of processing time can be shortened without increasing the number of lines, facility cost for processing the substrates B can be reduced.

Further, for example, by making a substrate B on the import conveyor C311 on standby (see FIGS. 7A to 7D), after a preceding substrate B is processed by the ball filling unit G1 located at the downstream side, the substrate B on standby can be conveyed to the first ball filling unit G1 immediately. The same applies to the other import conveyors C11 and C321 (see FIGS. 7A to 7D).

Thus, since the substrates B are always on standby at the upstream sides of the flux application unit F and the ball filling units G1, G2, waste time (conveyance loss) associated with the conveyance of the substrates B can be decreased to approximately zero. Therefore, the flux application unit F and the ball filling units G1, G2 which need twice the processing time with respect to the flux application unit F can run at full operation successively.

Further, operation time of the first ball filling unit G1 and the second ball filling unit G2 (process start time for each substrate B) may be shifted by a predetermined time or may be almost the same. In either case, the standby time for the ball filling units G1, G2 can be approximately zero by using the conveying devices 21, 22, 23 and the bypass conveyor C313, C323.

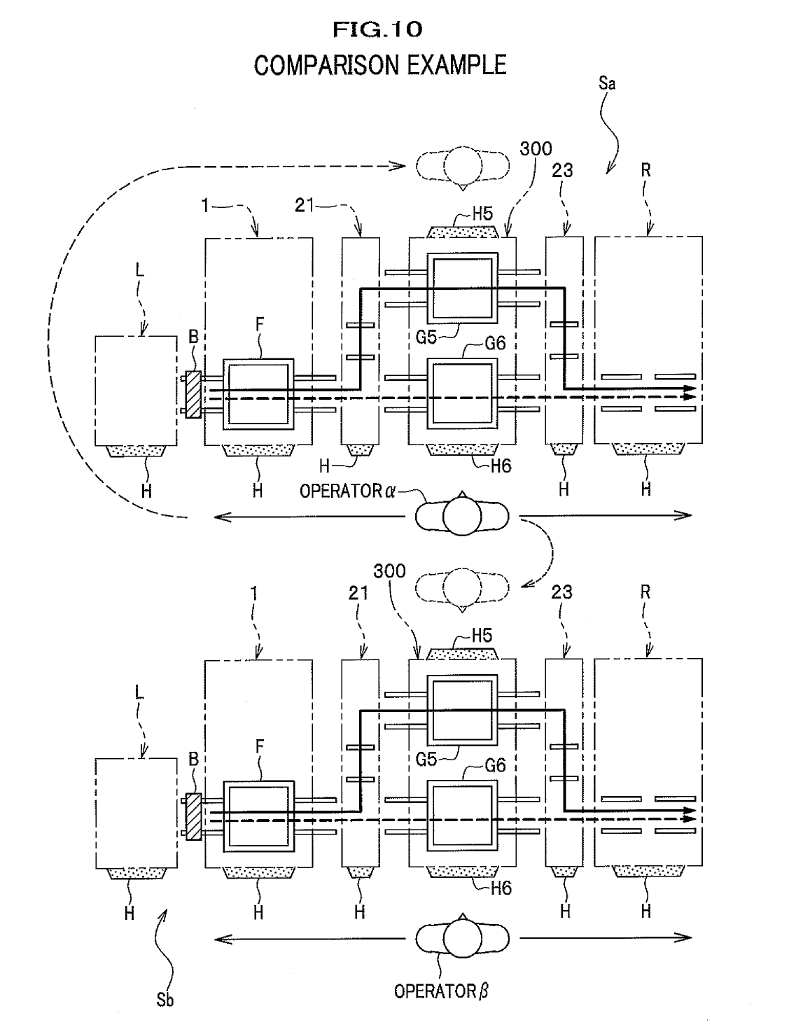

Further, as illustrated in FIG. 1, the operator can have a reduced management load by arranging the two ball printer 31, 32 (ball filling units G1, G2) in series. FIG. 10 is a plan view illustrating a structure of the electrode forming device according to a comparison example. In FIG. 10, two electrode forming devices Sa, Sb are illustrated.

In the comparison example in FIG. 10, one ball printer 300 is installed via the conveying device 21 at the downstream side of the flux printer 1. The ball printer 300 has two ball filling units G5, G6 arranged in parallel. Normally, the operation sections/display sections of the ball filling units G5, G6 are provided in areas indicated by signs H5, H6, respectively.

With this circumstance, when monitoring the ball filling unit G5, an operator α needs to go around from one side (left side in FIG. 10) of the electrode forming device Sa toward the operation section and the like indicated by the sign H5 as illustrated by an arrow indicated by a broken line. Further, the operator α needs to go back to the operation section and the like indicated by the signs H, H6. Consequently, the operator α needs to perform very burdensome operation.

It can also be considered that operators α, β manage the operation section and the like of the electrode forming devices Sa, Sb within an area where the operators α, β can move in a lateral direction in FIG. 10. In this case, the operator a manages the operation section and the like indicated by the signs H, H6 of the electrode forming device Sa and the operation section and the like indicated by the sign H5 of the electrode forming device Sb.

However, since the electrode forming device Sb is managed by the two operators α, β, such a managing system is not desirable in production control. Since quality of the substrates B finally acquired differs subtly per operator, one operator is desirably assigned to one electrode forming device.

While, in the embodiment, since the two ball filling units G1, G2 (see FIG. 1) are arranged in series, one operator can manage one electrode forming device S. Further, since all the operation sections and the like indicated by the sign H are arranged on one side, the operator only needs to go back and forth on a linear path, and a burden on the operator reduces.

### Second Embodiment

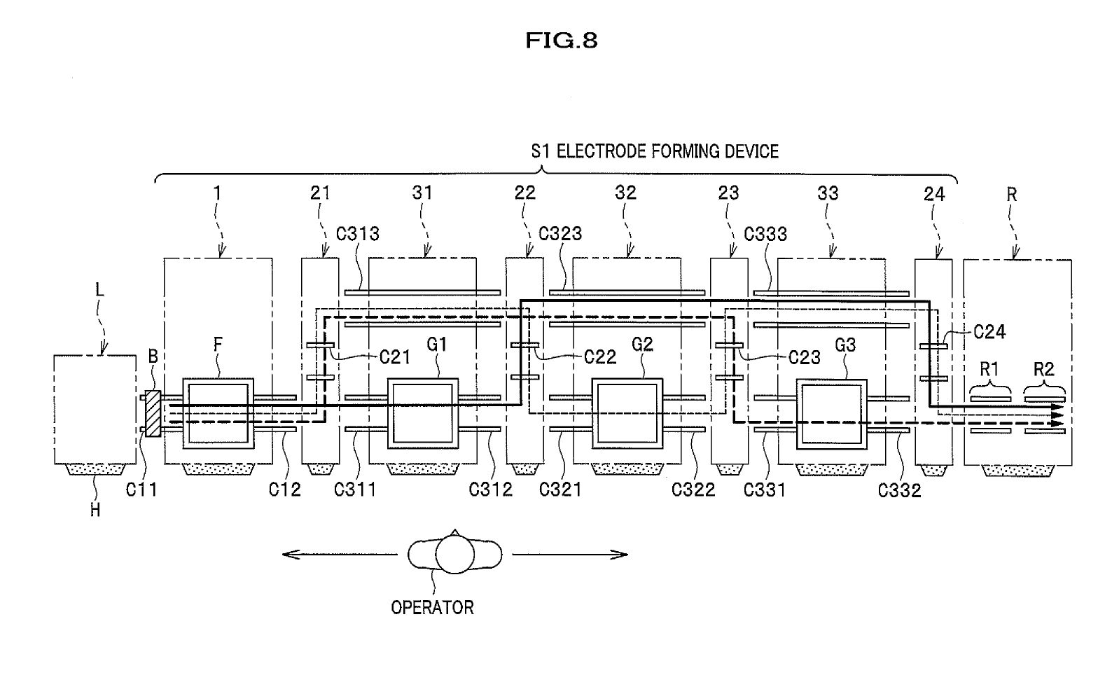

An electrode forming device S1 according to a second embodiment (see FIG. 8) differs from the first embodiment in that a third ball printer 33 and a fourth conveying device 24 are provided between the third conveying device 23 and the inspection/repair device R, and in that the processing time (for example, 60 seconds) of the ball printer 31, 32, 33 is triple the processing time (for example, 20 seconds) of the flux printer 1. Since other aspects are the same as those of the first embodiment, the different aspects will be explained and the same aspects as those of the first embodiment will not be explained.

### <Structure of the Electrode Forming Device>

FIG. 8 is a schematic plan view illustrating a structure including an electrode forming device according to the second embodiment of the invention, a loader and an inspection/repair device. Arrows indicated by a thick line, a thick broken line and a thin broken line indicate conveyance paths for the substrate B, respectively.

The third ball printer 33 is arranged at a downstream side of the third conveying device 23. The third ball printer 33 has an import conveyor C331, a third ball filling unit G3, the export conveyor C332 and a third bypass conveyor C333.

Since the structures of the import conveyor C331, the third ball filling unit G3 and the export conveyor C332 are the same as those of the import conveyor C311, the first ball filling unit G1 and the export conveyor C312 in the first embodiment (see FIG. 1), the explanations thereof will be omitted.

The third bypass conveyor C333 (bypass path) is a conveyor which conveys the substrate B to a downstream side in such a way as to bypass the third ball filling unit G3. The upstream end of the third bypass conveyor C333 is adjacent to the third conveying device 23 and the downstream end thereof is adjacent to the fourth conveying device 24.

The fourth conveying device 24 has a conveying unit (not shown) which conveys the conveyor C24 in the up-down direction in FIG. 8. The conveying unit conveys the conveyor C24 to a position adjacent to the export conveyor C332 of the third ball printer 33 or a position adjacent to the third bypass conveyor C333. The structure of the fourth conveying device is the same as that of the first conveying device 21 (see FIG. 1) mentioned above and the explanation thereof will be omitted.

In the second embodiment, a “bypass unit” which conveys the substrate B to one ball filling unit and conveys the substrate B in such a way as to bypass the other ball filling units is structured to include the conveying devices 21, 22, 23, 24 and the bypass conveyors C313, C323, C333.

### <Process of the Electrode Forming Device>

Processes executed by the third conveying device 23 and the fourth conveying device 24 will be explained hereinbelow. The processes executed by the flux printer 1, the first conveying device 21, the first ball printer 31, the second conveying device 22 and the second ball printer 32 are the same as those in the first embodiment, the explanations thereof will be omitted.

### (Conveying to the Third Ball Filling Unit)

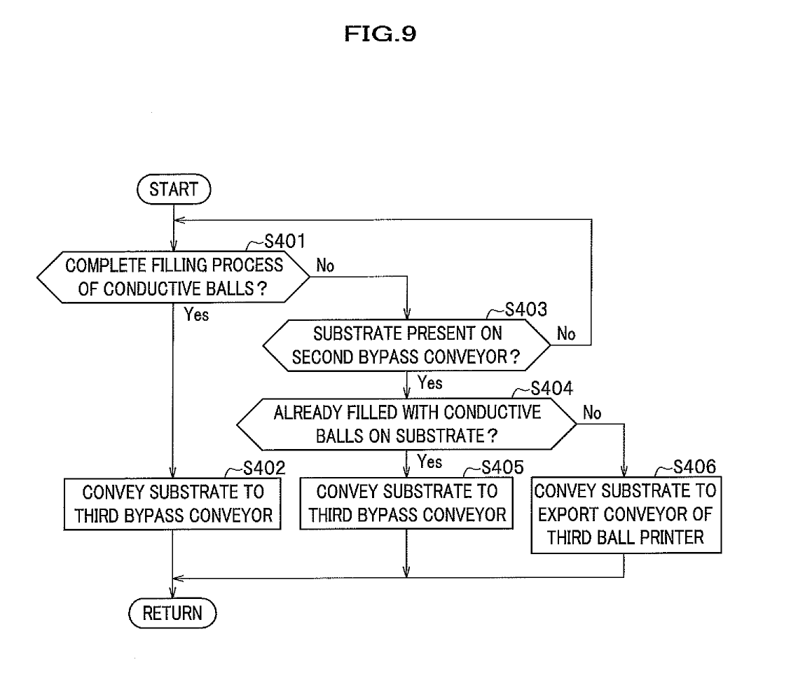

FIG. 9 is a flowchart illustrating processes of the third conveying device.

In step S401, the control device decides whether the filling process of the conductive balls by the second ball filling unit G2 completes. In case that the filling process of the conductive balls completes (S401: Yes), the control device conveys the substrate B to the third bypass conveyor C333 by the third conveying device 23 in step S402 (see the arrow indicated by the thin broken line in FIG. 8).

On the other hand, in case that the filling process of the conductive balls by the second ball filling unit G2 does not complete (S401: No), the control device decides whether the substrate B is present on the second bypass conveyor C323 in step S403.

In case that the substrate B is present on the second bypass conveyor C323 (S403: Yes), the control device decides whether the conductive balls have been already filled on the substrate B in step S404. In other words, the control device decides whether the above mentioned substrate B has been conveyed via the export conveyor C312 of the first ball printer 31.

In case that the conductive balls have been already filled on the substrate B on the second bypass conveyor C323 (S404: Yes), the control device conveys the substrate B to the third bypass conveyor C333 by the third conveying device 23 in step S405 (see the arrow indicated by the thick line in FIG. 8).

In case that the conductive balls are not filled on the substrate B on the second bypass conveyor C323 (S404: No), the control device conveys the substrate B to the import conveyor C331 by the third conveying device 23 in step S406 (see the arrow indicated by the thick broken line in FIG. 8). The substrate B is filled with the conductive balls by the third ball filling unit G3.

Since the process executed by the fourth conveying device 24 is the same as that of the third conveying device 23 (see FIG. 6) explained in the first embodiment, the explanation thereof will be omitted.

### <Effect>

According to the electrode forming device S1 according to the second embodiment, even when the processing time (for example, 60 seconds) of the ball printer 31, 32, 33 is triple the processing time (for example, 20 seconds) of the flux printer 1, the substrate B can be conveyed without conveyance loss.

In this case, the processing time required for one substrate B can be shortened to one-third compared with a case where one ball printer is arranged at a downstream side of one flux printer.

### <<Modification>>

The electrode forming devices S, S1 according to the invention are explained, but the invention is not limited to each embodiment described above and can be modified without departing from the scope of the invention.

For example, arranging the two ball printer 31, 32 in series is explained in the first embodiment and arranging the three ball printer 31 to 33 in series is explained in the second embodiment, but the invention is not limited thereto.

In other words, in case that the processing time of the flux application unit F is 1/N (N: natural number) of the processing time of the ball filling unit, the number of N ball printers are preferably arranged in series. In this case, the substrate B can be processed in time of 1/N compared with a case where one ball printer is arranged at a downstream side of the flux printer 1.

Further, in the first embodiment, arranging one bypass conveyor C313 in the first ball printer 31 and arranging one bypass conveyor C323 in the second ball printer 32 is explained, but the invention is not limited thereto. In other words, each ball printer 31, 32 may have a plurality of bypass conveyors arranged in parallel. In this case, the bypass conveyors may be used as standby positions for the substrates B.

Still further, each embodiment explains the structure in which, for example, the first ball printer 31 includes the bypass conveyor C313, but the invention is not limited thereto. In other words, the bypass conveyor C313 may be separated from the first ball printer 31. The same applies to the bypass conveyors C323, C333.

Yet further, each embodiment explains that the conveying devices 21 to 24 are separated from the flux printer 1 and the ball printers 31 to 33, but the invention is not limited thereto. For example, the conveying device 21 may be integrated into the flux printer 1 or the first ball printer 31. The same applies to the other conveying devices 22 to 24.

What is claimed is:

1. An electrode forming device comprising:
a flux application unit that applies flux on a substrate;
a plurality of ball filling units that are arranged in series at a downstream side of the flux application unit and fill a conductive ball on the substrate applied with the flux to form an electrode; and
a bypass unit that conveys the substrate to one ball filling unit and conveys the substrate in such a way as to bypass other ball filling unit.

2. The electrode forming device according to claim 1, wherein the bypass unit has a bypass path arranged in parallel with each ball filling unit, and a conveying unit that is arranged between the flux application unit and each ball filling unit and conveys the substrate received from an upstream side of the conveying unit to either the ball filling unit or the bypass path located at a downstream side of the conveying unit.

3. The electrode forming device according to claim 1, wherein the plurality of ball filling units comprise a first ball filling unit that is arranged at a downstream side of the flux application unit and a second ball filling unit that is arranged at a downstream side of the first ball filling unit, and the bypass unit comprises a first bypass unit that conveys the substrate applied with the flux by the flux application unit to the second ball filling unit in such a way as to bypass the first ball filling unit and a second bypass unit that conveys the substrate filled with the conductive ball by the first ball filling unit to a downstream side in such a way as to bypass the second ball filling unit.

4. An electrode forming method comprising steps of:
applying flux on a substrate by a flux application unit;
filling a conductive ball by one of a plurality of ball filling units arranged in series on the substrate applied with the flux by applying the flux to form an electrode; and
conveying the substrate to one ball filling unit and conveying the substrate in such a way as to bypass other ball filling unit.
